(19) United States
(12) Patent Application Publication
(10) Pub. No.: US 2008/0019219 A1
(43) Pub. Date: Jan. 24, 2008

(54) ELECTRONIC TIMEPIECE INCLUDING AN ADDED PARTITION AND ASSOCIATED ASSEMBLY METHOD

(75) Inventors: Brice Robin, La Chaux-de-Fonds (CH); Pierre-Andre Noirjean, Develier (CH)

Correspondence Address: GRIFFIN & SZIPL, PC, SUITE PH-1, 2300 NINTH STREET, SOUTH, ARLINGTON, VA, 22204, US

(73) Assignee: ETA SA Manufacture Horlogere Suisse, Grenchen (CH)

(21) Appl. No.: 11/777,418

(22) Filed: Jul. 13, 2007

(30) Foreign Application Priority Data
Jul. 19, 2006 (EP) 06117501.4

(51) Int. Cl. G04B 37/00; G04D 99/00

(52) U.S. Cl. 368/88; 29/896.33

(57) ABSTRACT

The electronic timepiece (10) includes a case (12) that contains at least one first and one second electronic module (14, 16) powered by a battery (18). The case (12) is formed by a middle part (20), which is closed by a protective crystal (22) placed above a display device (24) and by a cover (26) added to the case (12). The case (12) includes an added partition (32), which is secured to the middle part (20) and which delimits a top compartment (34) containing the first electronic module (14) and a bottom compartment (36) containing the second electronic module (16). The battery (18) is arranged in a complementary housing arranged in the bottom face (40) of the partition (32). A method of assembling the timepiece (10) is also provided.

This application claims priority from European Patent Application No. EP 06117501.4, filed Jul. 19, 2006, the entire disclosure of which is incorporated herein by reference.

### FIELD OF THE INVENTION.

The invention concerns an electronic timepiece and a method for the assembly thereof.

### BACKGROUND OF THE INVENTION

The invention concerns more particularly an electronic timepiece comprising a case that contains at least one first and one second electronic modules electrically connected to each other and powered by a battery, wherein the case is formed by a middle part that is closed, in the top part thereof, by a protective crystal placed above a display device and, in the bottom part thereof, by a cover added to the case.

US Patent No. 2005/0253047 discloses and shows a timepiece formed by a wristwatch comprising time functions such as time display and auxiliary functions to the time display formed by functions for measuring the pulse of the wearer of the watch. The time functions and the watch display control are processed by an electronic circuit arranged on a top printed circuit board which is secured in the middle part. The pulse measuring functions are processed by an electronic circuit arranged on a bottom printed circuit board which is secured to the bottom of the cover.

In this type of timepiece, the assembly of the various components which are superposed in the case is relatively complex. Securing means have to be provided inside the case, especially adapted to a given configuration of the timepiece. When one wishes to replace one electronic module with another electronic module, the structure of the case has to be altered which raises problems of cost and flexibility in the production line.

Moreover, the securing systems that are provided in the case are not completely satisfactory and some components, such as the battery, are not sufficiently held.

It has also been observed that, when the battery is changed, the electronic modules are very exposed which can lead to deterioration having a negative effect on the reliability of the timepiece.

It is an object of the invention to overcome these drawbacks by proposing a simple and economical solution.

### SUMMARY OF THE INVENTION

The invention therefore proposes a timepiece of the type previously described, characterized in that the case includes an added partition or wall, which is secured to the middle part and which delimits, in the top part of the case, a top compartment containing the first electronic module, and in the bottom part of the case, a bottom compartment containing the second electronic module, and in that the battery is arranged in a complementary housing arranged in the bottom face of the partition.

Owing to the invention, the two electronic modules are better insulated from each other and they are better held in the case. Moreover, the battery can be changed more easily and the arrangement thereof in the partition housing facilitates the electric connection thereof to the electronic modules.

Preferably, the second electronic module is formed by a printed circuit board carrying electronic components and it is secured to the inner face of the cover. The cover includes several studs which are integral with the cover and which extend vertically through associated holes arranged in the printed circuit board. The printed circuit board is held vertically on the cover by a deformation of the free end of each stud. This arrangement of the second electronic module on the cover facilitates both the assembly of the second electronic module in the case and changing the battery.

Advantageously, the first electronic module includes a male connector which extends downwards through an associated aperture in the partition, and the second electronic module comprises a complementary female connector which extends upwards to electrically connect the two electronic modules. The use of these connectors simplifies the electric connection of the second electronic module to the first electronic module, particularly by limiting the number of contact fixtures necessary for this connection. A more reliable electric connection is thus obtained and the number of assembly operations is reduced.

Preferably, the first electronic module comprises a printed circuit board that is secured to the middle part and the male connector is rigidly fixed to the bottom face of the printed circuit board. The first electronic module includes the display device, a watch circuit, and a display control circuit, and the second electronic module is dedicated to auxiliary functions such as the pulse measuring functions. A perfectly modular construction is thus obtained and it is possible to alter the second electronic module without altering the first electronic module.

According to an advantageous embodiment, the watch circuit and the display control circuit are arranged on the printed circuit board. The display device and the printed circuit board are fixed to a spacer inserted between the display device and the printed circuit board to form the first electronic module. The spacer is fixed to the middle part. Owing to this embodiment, the assembly operations are facilitated, and the first electronic module forms an assembly that is easier to handle. Moreover, by keeping a spacer with an identical external peripheral structure, it is possible to alter the printed circuit board and the display device, without this requiring any alteration to the structure of the top compartment of the case.

Preferably, the display device is secured in a removable manner to the spacer by an elastic male and female joint, which allows the elements forming the display device to be changed more quickly and simply, while keeping the same spacer.

Advantageously, the bottom of the battery housing comprises holes giving access to test and/or programming zones of the first electronic module. Thus, the first electronic module is protected by the partition or wall and it is possible to act on the first electronic module without dismantling the partition.

The partition extends substantially over the entire surface of the middle part in a parallel plane to the general plane of the cover. The cover is secured to the partition which is axially inserted between the middle part and the cover. A “sandwich” assembly is obtained which is easy to mass-produce and which provides good protection for the first electronic module when the battery is changed or one wishes to act on the second electronic module.

The invention also proposes a method of assembling a timepiece of the type previously described, characterized in that it comprises the following successive steps:
inserting the first electronic module in the middle part,
fixing the partition onto the middle part,
mounting the battery in a housing arranged on the bottom face of the partition,
fixing the cover carrying the second electronic module on the case.

Advantageously, there is a step of securing the second electronic module onto the cover, which comprises the following successive steps: positioning the printed circuit board of the second electronic module on the studs of the cover, andapplying thermo-welding to the free ends of the studs so as to create localised deformations retaining the printed circuit board against the inner face of the cover.

### BRIEF DESCRIPTION OF THE DRAWINGS

Other features and advantages of the present invention will appear more clearly upon reading the following detailed description, made with reference to the annexed drawings, given by way of non-limiting example and in which:

FIG. 1 is an exploded perspective view, which shows a preferred embodiment of an electronic timepiece according to the invention,

FIG. 2 is a view along the transverse cross-sectional plane 2-2 which shows the timepiece of FIG. 1;

FIG. 3 is an exploded perspective view which shows a first electronic module fitted to the timepiece of FIG. 1;

FIG. 4 is a view along the transverse cross-sectional plane 4-4 which partially shows the first electronic module and the arrangement of a backlighting light emitting diode;

FIG. 5 is an exploded perspective view which shows the case of the timepiece of FIG. 1 after it has been turned over and the first electronic module has been inserted and before the partition of the invention has been mounted;

FIG. 6 is a similar perspective view to FIG. 5, which shows the case after the partition has been mounted and before the battery powering the timepiece has been mounted;

FIG. 7 is a similar exploded perspective view to that of FIG. 5, which shows the case after the battery has been installed and before the cover carrying a second electronic module has been mounted;

FIG. 8 is a flow diagram, which shows the timepiece of FIG. 1 and the electronic modules thereof.

### DETAILED DESCRIPTION OF THE INVENTION

In the following description, an orthogonal frame of reference (wherein V, L, T respectively define the vertical V, longitudinal L and transverse T directions) will be used in a non limiting manner. Similar or identical elements may be designated by the same references.

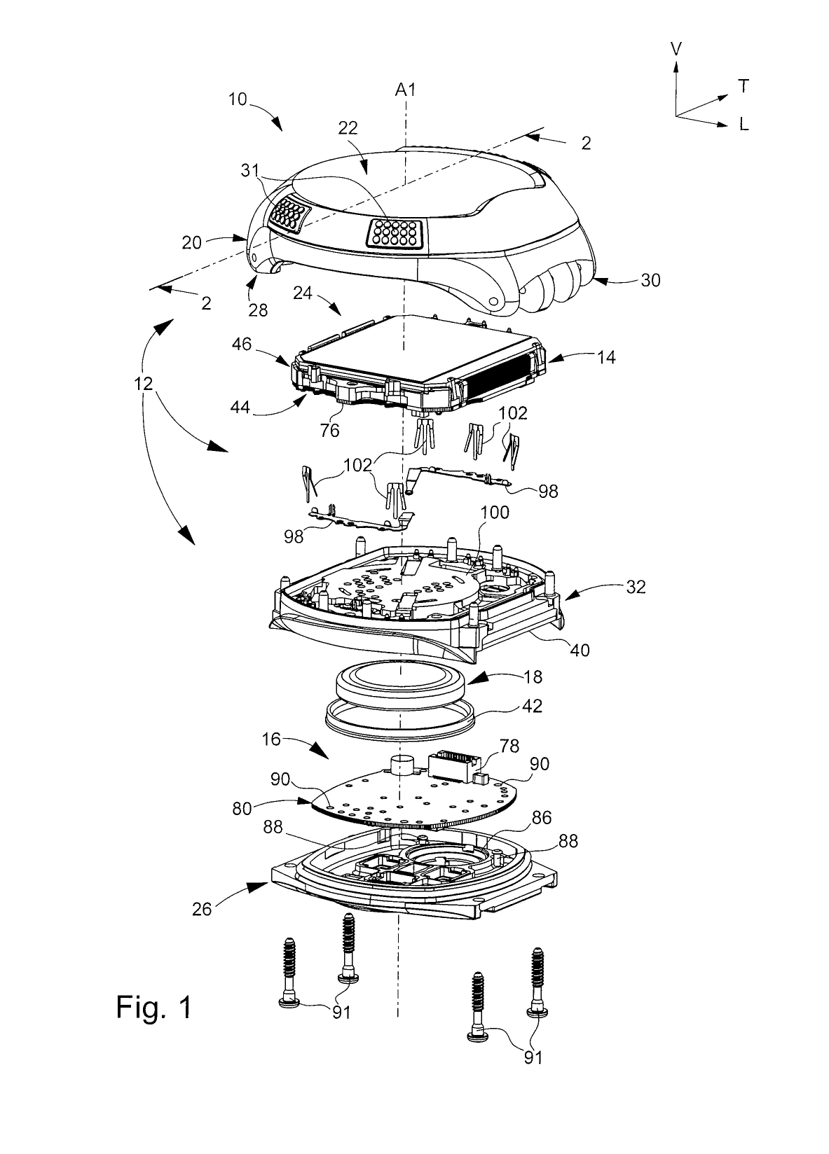

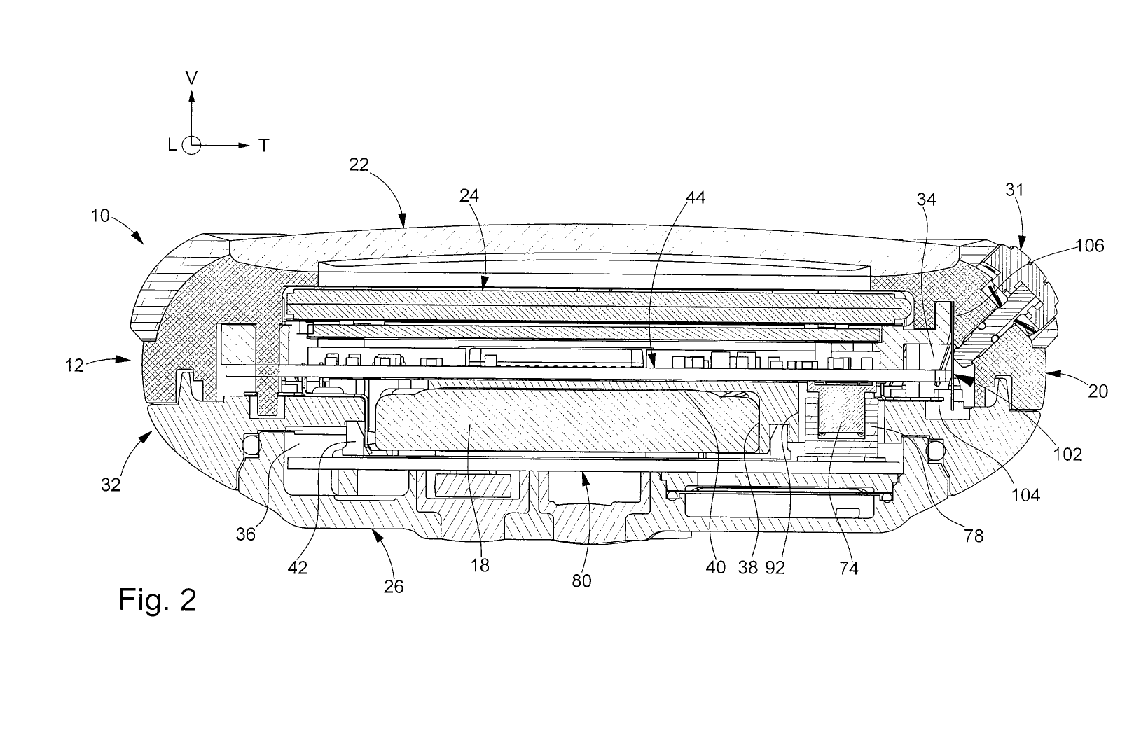

FIGS. 1 to 8 show the various elements forming an electronic timepiece 10 made in accordance with the teaching of the invention in the form of a wristwatch.

Timepiece 10 comprises a case 12, which contains first and second electronic modules 14, 16 electrically connected to each other and supplied with electric current by a battery 18. The electronic modules 14, 16 are stacked along a vertical axial direction A1.

In the following description, an axial orientation along vertical axial direction A1 will be used in a non-limiting manner.

Case 12 is formed by an overall circular middle part 20 which is closed, in the top part thereof, by a protective crystal 22 placed above a display device 24 and, in the lower part thereof, by a cover 26 added to the case 12.

Middle part 20, which extends substantially in a horizontal plane, comprises in the longitudinal end edges thereof, horns 28, 30, for attaching the strands of a wristband or bracelet (not shown) and, in the transverse end edges thereof, push-buttons 31 for manually controlling timepiece 10.

According to the teachings of the invention, case 12 includes an added partition or wall 32, which is fixed to middle part 20 and which delimits in the top part of case 12, a top comportment 34 containing first electronic module 14 and, in the bottom part of case 12, a bottom compartment 36 containing second electronic module 16.

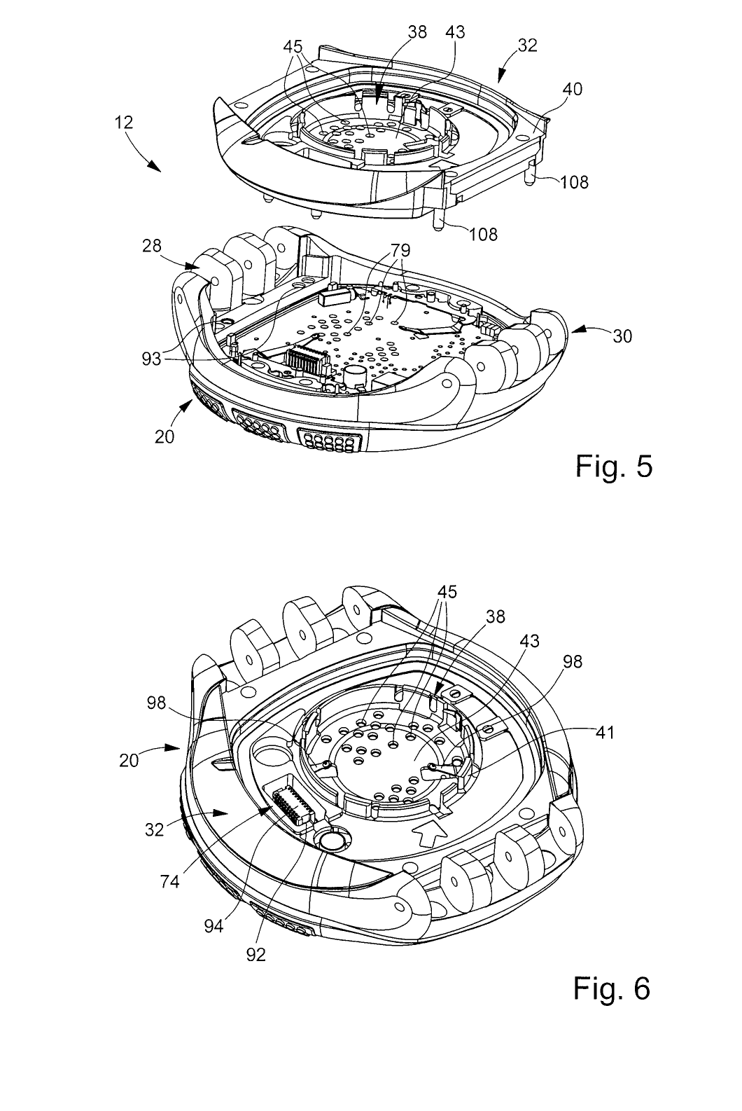

Battery 18 is arranged in the bottom compartment 36, between partition 32 and the second electronic module 16, in a complementary housing 38 arranged in the bottom face 40 of partition 32. Preferably, as shown in particular in FIGS. 5 to 7, housing 38 is made integral with partition 32, here in the form of an axial skirt 41 comprising axial notches which facilitate the deformation of axial skirt 41 radially outwards to allow battery 18 to be inserted in housing 38. A securing ring 42 is fitted onto the external axial walls of axial skirt 41, after insertion of battery 18, so as to retain battery 18 in its housing 38. The bottom 43 of housing 38 includes orifices 45, which provide access to test and/or programming zones of first electronic module 14.

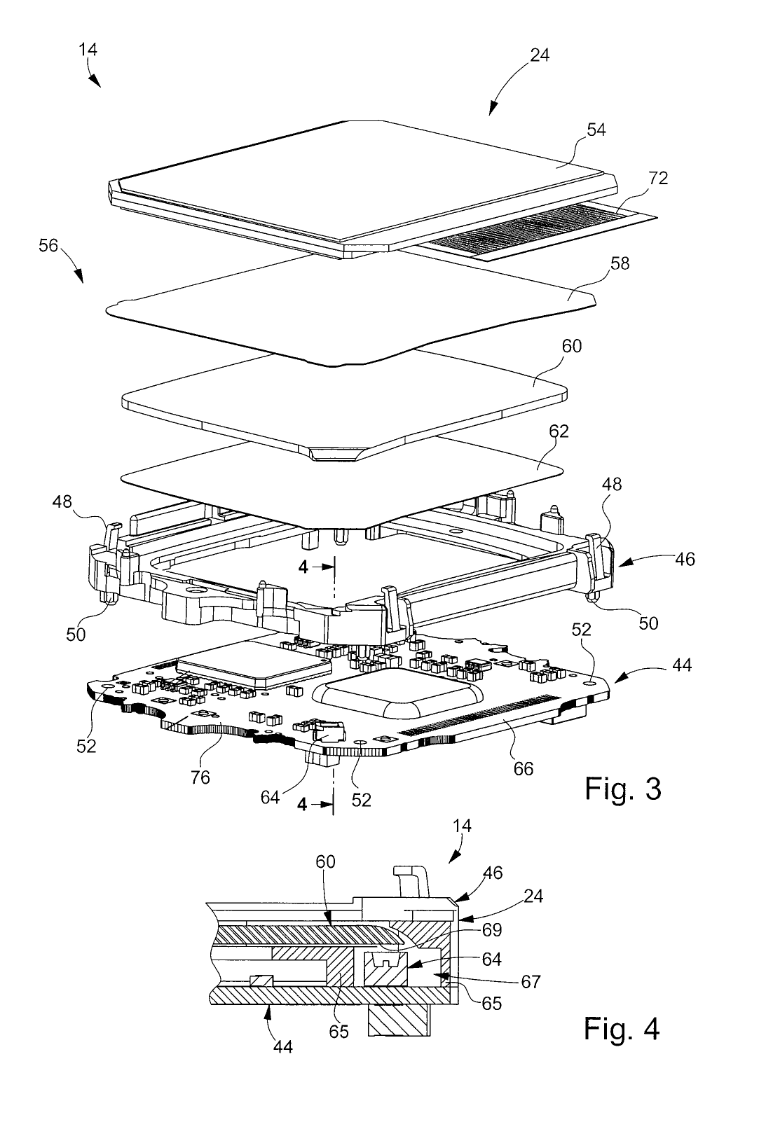

A preferred embodiment of the first electronic module 14 is shown in more detail in FIG. 3.

The first electronic module 14 is formed here by the assembly of a display device 24 with a first printed circuit board 44, an assembly spacer 46 being axially inserted between display device 24 and printed circuit board 44.

Spacer 46 has the shape here of an substantially rectangular frame which is received in a complementary manner in top compartment 34 of case 12 and which is secured to middle part 20. Spacer 46 comprises, in the top part thereof, elastic hooks 48, which are provided to allow display device 24 to fit elastically onto spacer 46, and it comprises, in the bottom part thereof, studs 50, which are received in complementary holes 52 of the first printed circuit board 44 so as to retain first printed circuit board 44 axially against the bottom face of spacer 46.

The display device 24 is preferably formed by a liquid crystal cell 54 of generally rectangular shape arranged above a backlighting device 56. Backlighting device 56 includes here, from top to bottom, a diffusion filter 58, a waveguide 60, a reflector filter 62 and a light emitting diode 64, which is mounted on the top face 66 of the first printed circuit board 44 so as to emit light beams inside waveguide 60.

According to an advantageous embodiment, illustrated by FIGS. 3 and 4, light emitting diode 64 is arranged in a corner of the first printed circuit board 44, so that the diode is located in a corresponding corner of spacer 46. In this corner, spacer 46 has substantially vertical walls which define a recess 67. Recess 67 is open downwards to allow for inserting light emitting diode 64 and it is open upwards, opposite the entry surface 69 of waveguide 60, to allow the light rays to penetrate waveguide 60.

This recess 67 forms a screen which prevents the light rays emitted by light emitting diode 64 outside waveguide 60 from propagating inside middle part 20. This is particularly useful in the case where middle part 20 is made of a translucent material.

First printed circuit board 44 comprises a clock circuit 68 and a display control circuit 70, which is electrically connected to liquid crystal cell 54 via a flexible connector 72. Clock circuit 68 comprises a time base and it is provided for calculating conventional time functions, such as the current time, the date, etc.

A male connector 74 is rigidly mounted on the bottom face 76 of first printed circuit board 44 so as to allow first electric module 14 to be electrically connected to second electric module 16, via a complementary female connector 78. All of the electric connections of second electronic module 16 to the first electronic module 14 and to battery 14 pass through this female connector 78.

The bottom face 76 of the first printed circuit board 44 includes electric contact studs 79 which are arranged opposite associated orifices 45 of partition 32 and which form test and/or programming zones of first electronic module 14. These studs 79 allow, for example, the operation of clock circuit 68 and display control circuit 70 to be tested by means of an electronic test tool (not shown).

The second electric module 16 is formed here by a second printed circuit board 80 comprising electronic components dedicated to functions auxiliary to the time functions.

According to the example embodiment shown in the Figures, these auxiliary functions comprise functions linked to measuring the pulse of the wearer of the watch. Thus, the second printed circuit board 80 includes a pulse measuring unit 82 and a pulse measurement processing unit 84 which communicates the data to be displayed to the display control circuit 70, in particular the value of the wearer's pulse.

Of course, according to variants (not shown) of the invention, the auxiliary functions could include functions other than pulse measurement, for example altimeter, compass, satellite positioning, telephony functions, etc.

Advantageously, the second printed circuit board 80 is fixed to the inner face 86 of cover 26. Thus cover 26 includes several studs 88, which are made integral with cover 26 and which extend vertically through associated holes 90 arranged in the second printed circuit board 80. The second printed circuit board 80 is retained vertically against cover 26 by a deformation of the free end of each stud 88.

The female connector 78 is rigidly mounted on the top face of the second printed circuit board 80 and extends vertically upwards.

According to the preferred embodiment of the invention, cover 26 is secured to the bottom face 40 of partition 32, such that partition 32 is axially wedged between middle part 20 and cover 26. Cover 26 is fixed hereby means of four screws 91, which pass vertically through partition 32 to be screwed into threaded holes 93 of middle part 20.

Partition 32 extends substantially over the entire surface of middle part 20 in a horizontal plane, between horns 28, 30, such that partition 32 covers all of the bottom face 76 of the first printed circuit board.

Partition 32 includes an aperture 92 opposite the male connector 74, which enables male connector 74 to fit into female connector 78 through partition 32. Advantageously, the free end 94 of the male connector 74 is substantially flush vertically with the edge 96 of aperture 92, which guarantees proper protection of male connector 74, when cover 26 and the second electronic module 16 are dismantled.

Advantageously, the electric connection of the first electronic module 14 to battery 18 is achieved by means of two metal contact lugs 98 which are arranged in the first compartment 34, between the first printed circuit board 44 and the top face 100 of partition 32, and which extend partially over the bottom 43 of battery housing 38.

Push-buttons 31 are provided with metal contact strips 102, which are arranged in first compartment 34, between the external peripheral edge 104 of the first printed circuit board 44 and the inner axial wall 106 of middle part 20.

It will be noted that all of the small independent electric connecting elements, such as contact lugs 98 and contact strips 102 are arranged in top compartment 34. Thus, the electric connection of the second electronic module 16 is simplified since all the electric connections thereof pass through female connector 78. Moreover, when cover 26 is dismantled, for example to change battery 18, there is no risk of losing components or of contact lugs 98 and contact strips 102 being poorly positioned.

Electronic modules 14 and 16 of timepiece 10 according to the invention enjoy good mechanical and electric protection, in particular when battery 18 is being changed.

The method of assembly timepiece 10 according to the invention will now be described.

The first electronic module 14 is pre-assembled, by mounting display device 24, backlighting device 56 and first printed circuit board 44 on spacer 46, and then the first electronic module is axially inserted in middle part 20. Case 12 is then in the configuration shown in FIG. 5.

Contact lugs 98 and contact strips 102 are then arranged in their respective positions against the first printed circuit board 44.

Next, partition 32 is axially mounted against the bottom face of middle part 20 and fixed, for example by bonding. Partition 32 is centred, in a horizontal plane, relative to middle part 20, for example by means of centring studs 108 made integral with partition 32.

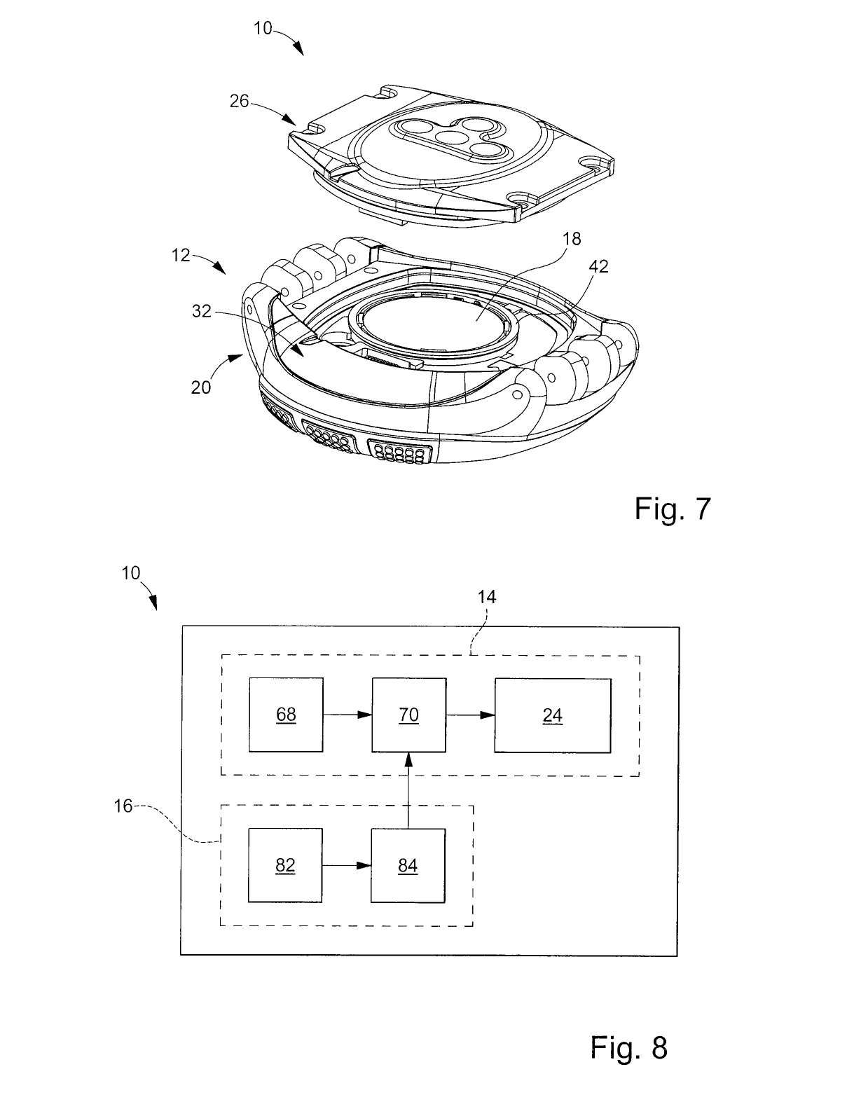

Battery 18 is inserted in its housing 38 and held in position by the fit of securing ring 42, as shown in FIG. 7.

After having secured second electronic module 16 to cover 26, the cover is secured to partition 32 by means of screws 91.

Preferably, the step of securing the second electronic module 16 to cover 26 includes a positioning step during which the studs 88 of cover 26 are axially inserted into corresponding holes 90 of the second printed circuit board 80. Holes 90 are sized so as to arranged a radial play between each stud 88 and the inner edge of the corresponding hole 90 to allow a slight clearance of the second printed circuit board 80 in a horizontal plane and thus facilitate the centring of the second printed circuit board 80 relative to the first printed circuit board 44 which is fixed. The final centring of the second printed circuit board 80 relative to first printed circuit board 44 is then determined by male connector 74 fitting inside female connector 78.

After this positioning step, the free end of each stud 88 is deformed by heat, which secures the second printed circuit board 80 on cover 26 by thermo-welding. At the end of the thermo-welding, the free end of each stud 88 is flattened and forms a disc of larger diameter than the diameter of the associated hole 90.

1. An electronic timepiece including:
a case that contains at least first and second electronic modules electrically connected to each other and powered by a battery, wherein the case is formed by a middle part, which is closed, in the top part thereof, by a protective crystal placed above a display device and, in the bottom part thereof, by a cover added to the case, wherein the case includes an added partition, which is secured to the middle part and which delimits, in the top part of the case, a top compartment containing the first electronic module and, in the bottom part of the case, a bottom compartment containing the second electronic module, and wherein the battery is arranged in a complementary housing arranged in the bottom face of the partition.

2. The timepiece according to claim 1, wherein the second electronic module is secured to the inner face of the cover.

3. The timepiece according to claim 2, wherein the second electronic module is formed by a printed circuit board carrying electronic components, and wherein the cover includes several studs, which are made integral with the cover and which extend vertically through associated holes arranged in the printed circuit board, and wherein the printed circuit board is retained vertically on the cover by a deformation of a free end of each stud.

4. The timepiece according to claim 1, wherein the first electronic module is secured to the middle part.

5. The timepiece according to claim 1, wherein the first electronic module includes a male connector that extends downwards through an associated aperture of the partition, and wherein the second electronic module includes a complementary female connector that extends upwards for the electric connection of the two electronic modules.

6. The timepiece according to claim 5, wherein the first electronic module includes a printed circuit board and wherein the male connector is rigidly connected to the bottom face of the printed circuit board.

7. The timepiece according to claim 1, wherein the first electronic module includes the display device, a clock circuit and a display control circuit, and wherein the second electronic module is dedicated to auxiliary functions to the time functions.

8. The timepiece according to claim 7, wherein the clock circuit and the display control circuit are arranged on a printed circuit board, wherein the display device and the printed circuit board are secured to a spacer inserted between the display device and the printed circuit board to form the first electronic module, and wherein the spacer is secured to the middle part.

9. The timepiece according to claim 8, wherein the display device is removably secured to the spacer by an elastic male and female joint.

10. The timepiece according to claim 1, wherein the portion of the added partition forming the bottom of the housing of the battery comprises holes formed therein for providing access to test zones, or programming zones, or test zones and programming zones, of the first electronic module.

11. The timepiece according to claim 1, wherein the partition extends substantially over the entire surface of the middle part in a parallel plane to a general plane of the cover.

12. The timepiece according to claim 11, wherein the cover is secured to the partition, the partition being inserted between the middle part and the cover.

13. A method of assembling a timepiece according to claim 1, wherein the method includes the following successive steps:
(a) inserting the first electronic module in the middle part;
(b) securing the partition to the middle part;
(c) mounting the battery in the housing arranged on the bottom face of the partition; and,
(d) securing the cover carrying the second electronic module on the case.

14. A method of assembling a timepiece according to claim 3, wherein the method includes the following successive steps:
(a) inserting the first electronic module in the middle part;
(b) securing the partition to the middle part;
(c) mounting the battery in the housing arranged on the bottom face of the partition; and
(d) securing the cover carrying the second electronic module on the case, wherein the method further includes a step of
(e) securing the second electronic module to the cover and the following successive steps of:
(f) positioning the printed circuit board of the second electronic module on the studs of the cover; and
(g) applying thermo-welding to the free ends of the studs so as to create localised deformations retaining the printed circuit board against the inner face of the cover.

15. The timepiece according to claim 2, wherein the first electronic module includes a male connector that extends downwards through an associated aperture of the partition, and wherein the second electronic module includes a complementary female connector that extends upwards for the electric connection of the two electronic modules.

16. The timepiece according to claim 3, wherein the first electronic module includes a male connector that extends downwards through an associated aperture of the partition, and wherein the second electronic module includes a complementary female connector that extends upwards for the electric connection of the two electronic modules.

17. The timepiece according to claim 4, wherein the first electronic module includes a male connector that extends downwards through an associated aperture of the partition, and wherein the second electronic module includes a complementary female connector that extends upwards for the electric connection of the two electronic modules.

18. The timepiece according to claim 7, wherein the auxiliary functions include time pulse functions.
